(19) United States
(12) Patent Application Publication
(10) Pub. No.: US 2011/0173079 A1
(43) Pub. Date: Jul. 14, 2011

(54) BIDDING MANAGEMENT METHOD AND SYSTEM USING BIDDING ATTRIBUTE INFORMATION

(75) Inventors: Ki Oh Kwon, Seongnam-si (KR); Jong Ho Park, Seongnam-si (KR); Yoon Hyoung Noh, Seongnam-si (KR); Young Ho Shin, Seongnam-si (KR)

(73) Assignee: NHN BUSINESS PLATFORM CORPORATION, Seongsam-si (KR)

(21) Appl. No.: 13/001,547

(22) PCT Filed: Jun. 30, 2009
(86) PCT No.: PCT/KR2009/003546

§ 371 Date: Mar. 18, 2011

(30) Foreign Application Priority Data
Jun. 30, 2008 (KR) 10-2008-0063088
Jun. 30, 2008 (KR) 10-2008-0063089
Jun. 30, 2008 (KR) 10-2008-0063090

(51) Int. Cl. G06Q 30/00

(52) U.S. Cl. 705/14.71

(57) ABSTRACT

Provided is a bid management method and system using bid attribute information. The bid management method may include receiving a bid request including bid attribute information of an advertisement listing, determining a display rank of the advertisement listing using the bid attribute information, and calculating a final bid amount of the advertisement listing based on the display rank of the advertisement listing.

### TECHNICAL FIELD

Exemplary embodiments of the present invention relate to a bid management method and system using bid attribute information, and more particularly, to a method and a system for determining whether to display an advertisement listing and a display rank of the advertisement listing based on bid attribute information including bid management on/off information, a desired display rank, and display setting on/off information.

### Background Art

According to a conventional cost per click (CPC) payment method, advertisers should calculate a bid amount of an advertisement for maintaining a desired rank and should reflect the amount on bidding. In this instance, when a display rank of an existing advertisement descends due to a change in a bidding atmosphere caused by the advent of a new advertisement, the advertisers should inconveniently set a new bid amount of the advertisement to maintain the desired rank.

Also, some advertisers themselves use a macro program, that is, an automatic program used to request a bid with a predetermined increment until a rank intended to be maintained is achieved. This program causes an excessive competition among advertisers as well as an increase in a bid amount, and as a result, the advertisers suffer great financial damage. Due to these circumstances, a vicious cycle continues between advertisers who distrust advertising providers, and advertising providers who lose their credit and suffer a reduction in sales.

Accordingly, there is a desire for a bid management method that may charge advertisers an amount based on a proper bid amount and may automatically change a bid amount and a display rank of an existing advertisement when a new advertisement is requested for bidding.

### DISCLOSURE OF INVENTION

### Technical Goals

Exemplary embodiments of the present invention provide a bid management method and system which may efficiently manage an advertisement listing requested for bidding by determining whether to display the advertisement listing and a display rank of the advertisement listing using bid attribute information included in a bid request of an advertiser.

Exemplary embodiments of the present invention also provide a bid management method and system which may perform an advertisement bidding to meet the demand of an advertiser by determining whether to display an advertisement listing and a display rank of the advertisement listing based on an initial bid amount, bid management on/off information, a desired display rank, and display setting on/off information.

Exemplary embodiments of the present invention also provide an automatic bid management method and system which may efficiently manage advertisement listings having similar bid amounts by managing advertisement listings requested for bidding through an advertisement group based on a ranking strategy set by an advertiser.

Exemplary embodiments of the present invention also provide an automatic bid management method and system which may charge an advertiser a proper amount by calculating a minimum bid amount to maintain a desired rank within a maximum bid amount set by the advertiser.

Exemplary embodiments of the present invention also provide an automatic bid management method and system which may reflect an opportunity cost of not displaying an advertisement listing reduced to a lower display rank by taking into consideration the advertisement listing not displayed due to a decline in a display rank when calculating a bid amount.

### Technical Solutions

An exemplary embodiment of the present invention discloses a bid management method including receiving a bid request including bid attribute information of an advertisement listing, determining a display rank of the advertisement listing using the bid attribute information, and calculating a final bid amount of the advertisement listing based on the display rank of the advertisement listing.

According to an aspect of the present invention, the bid attribute information may include (1) an initial bid amount, (2) a desired display rank, (3) bid management on/off information for determining whether an advertisement listing is a target for bid management, and (4) display setting on/off information for determining whether to display an advertisement listing based on whether a display rank of the advertisement listing meets a desired display rank of the advertisement listing.

According to an aspect of the present invention, the determining of the display rank of the advertisement listing may comprise determining an initial rank of the advertisement listing using an initial rank index based on the initial bid amount, determining whether to display the advertisement listing using the bid management on/off information, determining whether to display the advertisement listing using the initial rank and the desired display rank, and determining whether to display the advertisement listing using the display setting on/off information.

Another exemplary embodiment of the present invention discloses a bid management method including assigning an advertisement listing to an advertisement group based on rank setting information, extracting an advertisement listing to be displayed in a rank section from the advertisement listing using the advertisement group, and adjusting a bid amount of the advertisement listing.

According to an aspect of the present invention, the extracting of the advertisement listing to be displayed in the rank section from the advertisement listing using the advertisement group may comprise setting at least one rank section based on the advertisement group, distributing the advertisement listing to each rank section, and determining a display rank of the advertisement listing for each rank section.

According to an aspect of the present invention, the determining of the display rank of the advertisement listing for each rank section may comprise arranging an advertisement listing for bid management based on a quality index for each rank section, arranging an advertisement listing not for bid management based on an initial rank index for each rank section, and calculating the display rank of the advertisement listing based on the rank setting information for each rank section.

Still another exemplary embodiment of the present invention discloses a bid management system including a bid request receiving unit to receive a bid request including bid attribute information of an advertisement listing, a display rank determining unit to determine a display rank of the advertisement listing using the bid attribute information, and a bid amount calculating unit to calculate a final bid amount of the advertisement listing based on the display rank of the advertisement listing.

Still yet another exemplary embodiment of the present invention discloses a bid management system including an advertisement assigning unit to assign an advertisement listing to an advertisement group based on rank setting information, an advertisement extracting unit to extract an advertisement listing to be displayed in a rank section from the advertisement listing, and a bid amount adjusting unit to adjust a bid amount of the advertisement listing.

It is to be understood that both the foregoing general description and the following detailed description are exemplary and explanatory and are intended to provide further explanation of the invention as claimed.

### Advantageous Effect

According to embodiments of the present invention, an advertisement listing requested for bidding may be efficiently managed by determining whether to display the advertisement listing and a display rank of the advertisement listing using bid attribute information included in a bid request of an advertiser.

According to embodiments of the present invention, an advertisement bidding to meet the demand of an advertiser may be performed by determining whether to display an advertisement listing and a display rank of the advertisement listing based on an initial bid amount, bid management on/off information, a desired display rank, and display setting on/off information.

According to embodiments of the present invention, advertisement listings having similar bid amounts may be efficiently managed by managing advertisement listings requested for bidding through an advertisement group based on a ranking strategy set by an advertiser.

According to embodiments of the present invention, an advertiser may be charged a proper amount by calculating a minimum bid amount to maintain a desired rank within a maximum bid amount set by the advertiser.

According to embodiments of the present invention, an opportunity cost of not displaying an advertisement listing reduced to a lower display rank may be reflected by taking into consideration the advertisement listing not displayed due to a decline in a display rank when calculating a bid amount.

### BRIEF DESCRIPTION OF DRAWINGS

FIG. 1 is a diagram illustrating a process for displaying an advertisement listing requested for bidding using a bid management system according to an embodiment of the present invention.

FIG. 2 is a flowchart illustrating a bid management method according to an embodiment of the present invention.

FIG. 3 is a flowchart illustrating a process for determining a display rank of an advertisement listing according to an embodiment of the present invention.

FIG. 4 is a view illustrating an example of bid attribute information of an advertisement listing according to an embodiment of the present invention.

FIG. 5 is a view illustrating an example of calculating a display rank of an advertisement listing and determining a final bid amount of the advertisement listing according to an embodiment of the present invention.

FIG. 6 is a block diagram illustrating a structure of the bid management system according to an embodiment of the present invention.

FIG. 7 is a flowchart illustrating a bid management method according to another embodiment of the present invention.

FIG. 8 is a block diagram illustrating a process for extracting an advertisement listing to be displayed in a rank section according to another embodiment of the present invention.

FIG. 9 is a view illustrating an example of sorting advertisement listings requested for bidding into advertisement groups based on rank setting information according to another embodiment of the present invention.

FIG. 10 is a view illustrating an example of extracting an advertisement listing to be displayed in each rank section from advertisement listings requested for bidding according to another embodiment of the present invention.

FIG. 11 is a chart illustrating a bid management result obtained by applying the bid management method to an advertisement listing for bid management and an advertisement listing not for bid management according to another embodiment of the present invention.

FIG. 12 is a view illustrating an example of sorting advertisement listings requested for bidding into advertisement groups based on rank setting information according to another embodiment of the present invention.

FIG. 13 is a view illustrating a process for determining an advertisement listing to be displayed in each rank section from advertisement listings requested for bidding according to another embodiment of the present invention.

FIG. 14 is a view illustrating a bid management result obtained by applying the bid management method to an advertisement listing for bid management according to another embodiment of the present invention.

FIG. 15 is a block diagram illustrating the structure of a bid management system according to another embodiment of the present invention.

### BEST MODE FOR CARRYING OUT THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present.

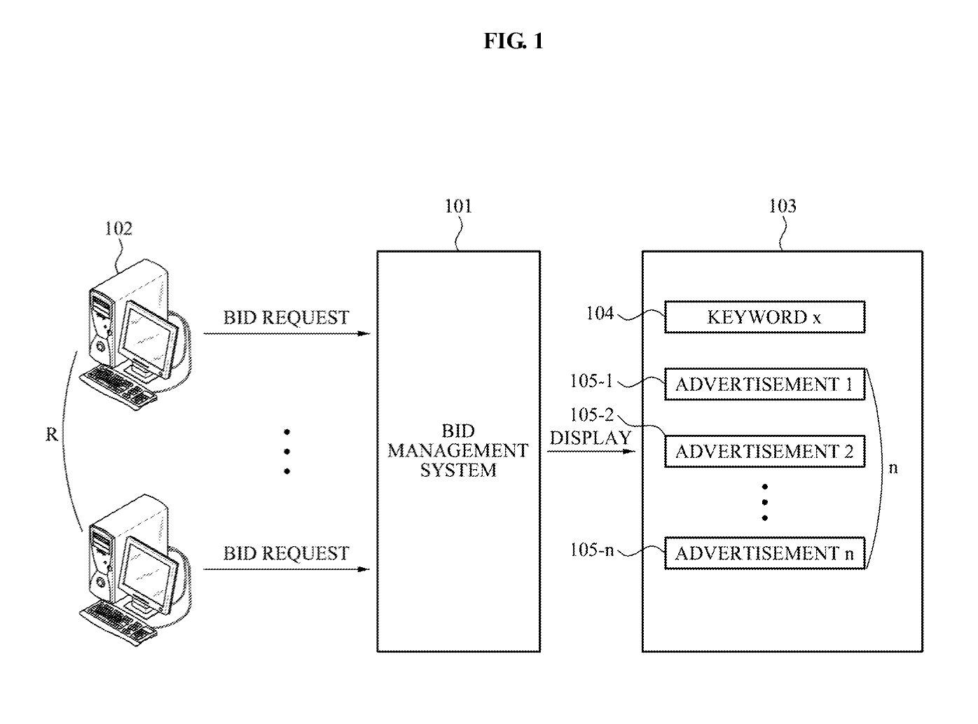

FIG. 1 is a diagram illustrating a process for displaying an advertisement listing requested for bidding using a bid management system 101 according to an embodiment of the present invention.

Referring to FIG. 1, the bid management system 101 may receive a bid request of an advertisement listing related to a keyword X 104 from a plurality of advertisers 102. That is, in the present invention, the advertisement listing may be plural. Hereinafter, description of an advertisement listing is about one of a plurality of advertisement listings. However, some of R advertisement listings may be displayed on a search result based on bid attribute information.

For example, the bid request may include bid attribute information. In this instance, the bid attribute information may include (1) an initial bid amount, (2) a desired display rank, (3) bid management on/off information for determining whether an advertisement listing is a target for bid management, and (4) display setting on/off information for determining whether to display an advertisement listing based on whether a display rank of the advertisement listing meets a desired display rank of the advertisement listing.

The initial bid amount is a maximum bid amount charged for an advertisement listing, and may represent an upper limit of a bid amount adjusted by the bid management system 101. In other words, the bid amount adjusted through the bid management system 101 may not be larger than the initial bid amount. In this instance, when an advertisement listing is not a target for bid management, a bid amount of the advertisement listing may be the same as an initial bid amount of the advertisement listing inputted when requesting a bid.

The bid management system 101 may determine a display rank of each of a plurality of advertisement listings requested for bidding, using bid attribute information. In this instance, after the bid management system 101 determines whether to display an advertisement listing, the bid management system 101 may determine a display rank of the advertisement listing by taking into consideration an advertisement listing not displayed.

Also, after the bid management system 101 determines the display rank of the advertisement listing, the bid management system 101 may calculate a final rank index of the advertisement listing using an initial rank index based on an initial bid amount. Also, the bid management system 101 may calculate a final bid amount of the advertisement listing using an initial rank index of a next-ranked advertisement listing.

When a searcher performs a search by inputting a keyword X 104, the bid management system 101 may display ‘n’ advertisement listings 105-1 to 105-n, of which display ranks have been determined, on a result document 103. In this instance, when the searcher selects one of the displayed advertisement listings, the bid management system 101 may charge an advertiser an amount based on a final bid amount of the selected advertisement listing. In this instance, a charge may be determined based on a final bid amount and click information of the selected advertisement listing.

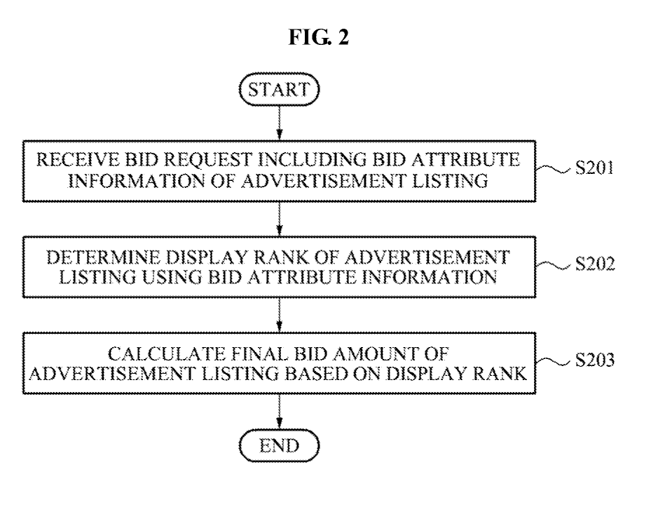

FIG. 2 is a flowchart illustrating a bid management method according to an embodiment of the present invention.

In operation S201, the bid management system 101 may receive a bid request including bid attribute information of an advertisement listing. For example, the bid attribute information may include (1) an initial bid amount, (2) a desired display rank, (3) bid management on/off information for determining whether an advertisement listing is a target for bid management, and (4) display setting on/off information for determining whether to display an advertisement listing based on whether a display rank of the advertisement listing meets a desired display rank of the advertisement listing.

The initial bid amount may be a maximum bid amount of an advertisement listing inputted by an advertiser. That is, the initial bid amount may represent a maximum bid amount that the advertiser may pay, and may stand for an upper limit within which a final bid amount may be adjusted. The desired display rank may refer to information of a location set by the advertiser, the location where an advertisement listing is displayed.

In this instance, the bid management on/off information may denote information for determining whether an advertisement listing is a target for bid management. That is, when bid management on/off information is ON, an advertisement listing may be a target advertisement listing for bid management, that is, a dynamic advertisement. Conversely, when bid management on/off information is OFF, an advertisement listing may be an advertisement listing that is not a target for bid management, that is, a static advertisement. For example, whether to display an advertisement listing for bid management and a display rank of the advertisement listing may be determined based on a desired display rank and display setting on/off information.

Also, the display setting on/off information may be information for determining whether to display an advertisement listing based on whether a display rank of the advertisement listing meets a desired display rank of the advertisement listing. When display setting on/off information is ON, an advertisement listing may be displayed even if a display rank does not meet a desired display rank. Also, when display setting on/off information is OFF and a display rank does not meet a desired display rank, an advertisement listing may not be displayed.

In this instance, the display rank, as compared with a desired display rank, may stand for an initial rank. Here, the initial rank may be determined by arranging an initial rank index generated from a combination of an initial bid amount and a quality index. The initial rank may represent a rank determined based on an initial bid amount before applying a desired display rank.

In operation S202, the bid management system 101 may determine a display rank of the advertisement listing using the bid attribute information. That is, the bid management system 101 may determine a display rank of an advertisement listing to be displayed on a search result page for a keyword. The display rank may be determined based on the number of inventories of the search result page.

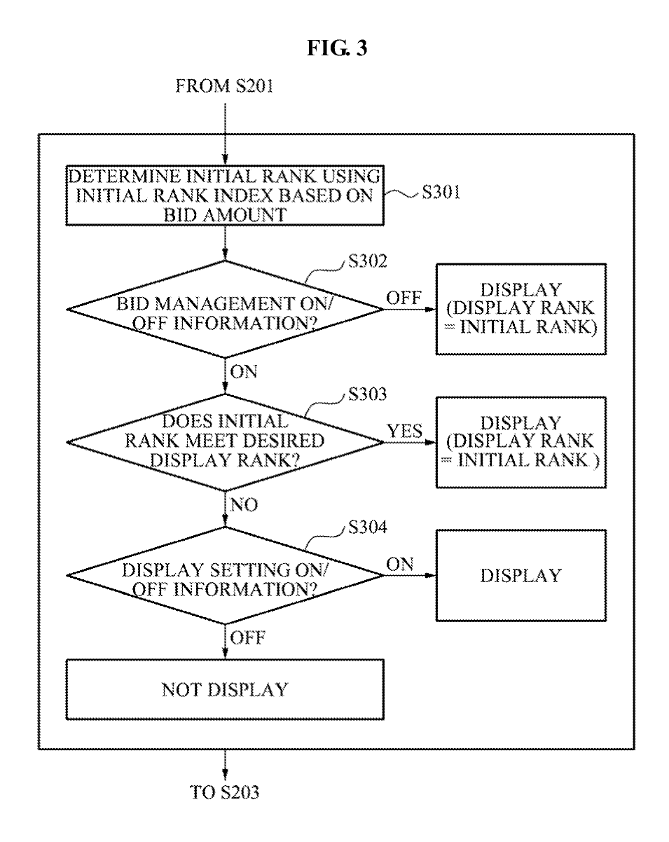

For example, the bid management system 101 may determine an initial rank of the advertisement listing using an initial rank index based on an initial bid amount. Also, the bid management system 101 may determine whether to display the advertisement listing using bid management on/off information. Also, the bid management system 101 may determine whether to display the advertisement listing using an initial rank and a desired display rank. Finally, the bid management system 101 may determine whether to display the advertisement listing using display setting on/off information. The operation S202 is described in more detail below with reference to FIG. 3.

In operation S203, the bid management system 101 may calculate a final bid amount of the advertisement listing based on the display rank of the advertisement listing. In this instance, the bid management system 101 may calculate a final bid amount of the advertisement listing in an ascending order of display rank.

In this instance, a final bid amount of an N^{th} ranked advertisement listing may be determined using a final rank index of an N+1^{th} ranked advertisement listing. For example, a final bid amount of an N^{th} ranked advertisement listing may be determined by applying a quality index of the N^{th} ranked advertisement listing to a final rank index of an N+1^{th} ranked advertisement listing.

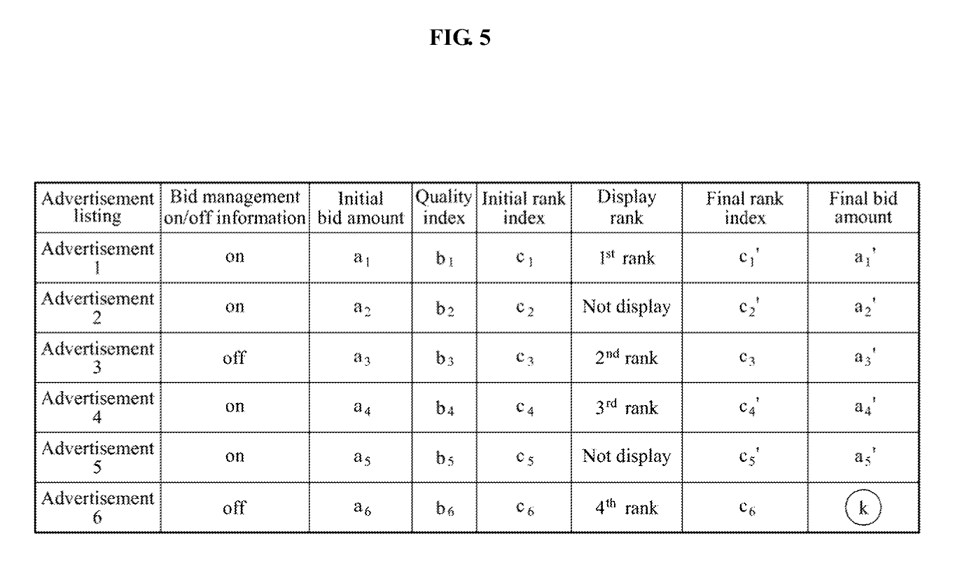

Also, the final rank index of the N+1^{th} ranked advertisement listing may be determined using an initial rank index of an N+2^{th} ranked advertisement listing. In this instance, the bid management system 101 may determine the final rank index of the N+1^{th} ranked advertisement listing based on bid management on/off information of the N+1^{th} ranked advertisement listing. That is, the bid management system according to an embodiment of the present invention may automatically adjust a final bid amount of a keyword advertisement within an initial bid amount of the advertisement set by an advertiser, and may determine the final bid amount as a minimum amount depending on bidding situations, thereby reducing the burden of the advertiser. The operation S203 is described in more detail below with reference to FIG. 5.

FIG. 3 is a flowchart illustrating a process for determining a display rank of an advertisement listing according to an embodiment of the present invention.

Referring to FIG. 3, in operation S301, the bid management system 101 may determine an initial rank of an advertisement listing using an initial rank index based on a bid amount. In this instance, the bid management system 101 may determine an initial rank by arranging an initial rank index based on an initial bid amount and a quality index. Here, the initial rank index may be arranged in a descending order.

For example, the initial rank index may be determined by multiplying an initial bid amount by a quality index. That is, the initial rank index may be determined based on a quality index. In this instance, the quality index may be an index indicating the quality of an advertisement listing. Specifically, the quality index may be determined by weighting a quality factor as a pre-evaluation factor and a click through ratio (CTR) as a post evaluation factor, respectively. Accordingly, an advertisement listing having a large quality index may be determined to have a high initial rank even if an initial bid amount of the advertisement listing is small.

As a result, according to an embodiment of the present invention, an advertiser may make efforts for improved quality of an advertisement listing to display the advertisement listing on the top of a search result page with a small bid amount. Then, users may be provided with an advertisement listing of a higher quality as a search result. Accordingly, advertising effects of the advertisement listing may be improved.

For example, operations S302, S303, and S304 may be performed in a descending order of initial rank over all advertisement listings requested for bidding. That is, the bid management system 101 may determine whether to display advertisement listings through the operations S302, S303, and S304 in a descending order of initial rank from a highest-ranked advertisement listing to a lowest-ranked advertisement listing.

In operation S302, the bid management system 101 may determine whether to display an advertisement listing using bid management on/off information. In this instance, when bid management on/off information of an advertisement listing is OFF, the bid management system 101 may determine the advertisement listing as a target to be displayed. That is, because the advertisement listing is not a target for bid management, the corresponding advertisement listing may be displayed without a separate processing operation.

Conversely, when bid management on/off information of an advertisement listing is ON, the bid management system 101 may determine whether to display the advertisement listing through a separate processing operation. In this instance, whether to display an advertisement listing, of which bid management on/off information is ON, may be determined through operation S303.

In operation S303, the bid management system 101 may determine whether to display an advertisement listing using an initial rank and a desired display rank. In this instance, when an initial rank of an advertisement listing meets a desired display rank of the advertisement listing, the bid management system 101 may determine the advertisement listing as a target to be displayed.

Conversely, when an initial rank of an advertisement listing does not meet a desired display rank of the advertisement listing, the bid management system 101 may determine whether to display the advertisement listing through the operation S304.

In operation S304, the bid management system 101 may determine whether to display an advertisement listing using display setting on/off information. In this instance, an advertisement listing, to which the operation S304 is applied, may be an advertisement listing of which bid management on/off information is ON and an initial rank does not meet a desired display rank.

In this instance, the bid management system 101 may determine an advertisement listing, of which display setting on/off information is OFF, as an advertisement listing not displayed. However, an advertisement listing not displayed may be used to calculate a final bid amount of an advertisement listing to be displayed. Also, the bid management system 101 may determine an advertisement listing, of which display setting on/off information is ON, as a target to be displayed.

According to an embodiment of the present invention, after determining whether to display an advertisement listing is made over a plurality of advertisement listings, the bid management system 101 may determine a display rank of an advertisement listing to be displayed, by taking into consideration an advertisement listing not displayed. That is, the bid management system 101 may determine whether to display an advertisement listing over all advertisement listings, and may determine a display rank of an advertisement listing to be displayed, by taking into consideration an advertisement listing not displayed.

That is, when an advertisement listing having an initial rank of a 4^{th} rank is determined not to be displayed, a display rank of an advertisement listing, which is determined as a target to be displayed and which has an initial rank of a 5^{th} rank, may be determined as a 4^{th} rank.

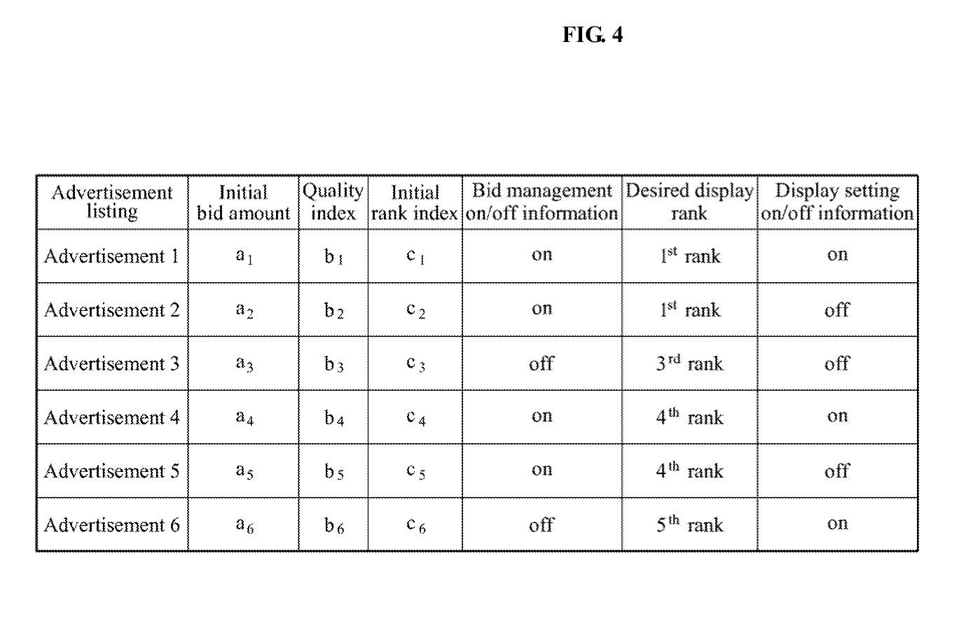

FIG. 4 is a view illustrating an example of bid attribute information of an advertisement listing according to an embodiment of the present invention.

Referring to FIG. 4, bid attribute information of each of a plurality of advertisement listings requested for bidding is shown. The bid attribute information may include (1) an initial bid amount, (2) a desired display rank, (3) bid management on/off information for determining whether an advertisement listing is a target for bid management, and (4) display setting on/off information for determining whether to display an advertisement listing based on whether a display rank of the advertisement listing meets a desired display rank of the advertisement listing.

In FIG. 4, an initial rank index may be used to determine an initial rank through operation S301. In this instance, the initial rank may be determined in a descending order of initial rank index. Also, the initial rank index cₙ may be determined by multiplying an initial bid amount aₙ by a quality index bₙ.

In operation S302, whether to display an advertisement listing may be determined based on bid management on/off information. Referring to FIG. 4, advertisement listings 3 and 6, of which bid management on/off information is OFF, may be determined as a target to be displayed through operation S302. Also, whether to display advertisement listings 1, 2, 4, and 5 may be determined through operation S303.

In operation S303, whether to display an advertisement listing may be determined based on whether an initial rank meets a desired display rank. An advertisement listing, of which an initial rank meets a desired display rank, may be determined as a target to be displayed. Conversely, whether to display an advertisement listing, of which an initial rank does not meet a desired display rank, may be determined through operation S304.

For example, in FIG. 4, when an initial rank of an advertisement listing 5 is a sixth rank, the initial rank of the advertisement listing 5 does not meet a desired display rank of the advertisement listing 5, and thus, the advertisement listing 5 may not be determined as a target to be displayed in operation S303. Conversely, when an initial rank of the advertisement listing 5 is a fourth rank or higher, that is, a first rank to a fourth rank, the initial rank of the advertisement listing 5 meets a desired display rank of the advertisement listing 5, that is, a fourth rank, and thus, the advertisement listing 5 may be determined as a target to be displayed.

In operation S304, whether to display an advertisement listing may be determined based on display setting on/off information. An advertisement listing, of which display setting on/off information is ON, may be determined as a target to be displayed. An advertisement listing, of which display setting on/off information is OFF, may be determined not to be displayed.

For example, as shown in FIG. 4, when an initial rank of an advertisement listing 2 does not meet a desired display rank of the advertisement listing 2 and display setting on/off information of the advertisement listing 2 is ON, the advertisement listing 2 may be determined not to be displayed. Also, even though an initial rank of an advertisement listing 4 does not meet a desired display rank, display setting on/off information of the advertisement listing 4 is ON, and thus, the advertisement listing 4 may be determined as a target to be displayed.

Through the above-described operations, when whether to display an advertisement listing is determined over all advertisement listings, the bid management system 101 may determine a display rank of an advertisement listing determined to be displayed, by taking into consideration an advertisement listing determined not to be displayed. Specifically, a display rank of an advertisement listing may be determined, other than an advertisement listing determined not to be displayed.

FIG. 5 is a view illustrating an example of calculating a display rank of an advertisement listing and determining a final bid amount of the advertisement listing according to an embodiment of the present invention.

The bid management system 101 may calculate a final bid amount of an advertisement listing based on a display rank of the advertisement listing. In this instance, the bid management system 101 may calculate a final bid amount of an N^{th} ranked advertisement listing by applying a quality index of the N^{th} ranked advertisement listing to a final rank index of an N+1^{th} ranked advertisement listing. Here, the final bid amount may be calculated in an ascending order of display rank.

For example, the final rank index of the N+1^{th} ranked advertisement listing may be determined based on bid management on/off information of the N+1^{th} ranked advertisement listing. Specifically, a final rank index of an N+1^{th} ranked advertisement listing, of which bid management on/off information is ON, may be determined based on a final rank index of an N+2^{th} ranked advertisement listing.

Also, a final rank index of an N+1^{th} ranked advertisement listing, of which bid management on/off information is OFF, may be determined as a value equal to an initial rank index of the N+1^{th} ranked advertisement listing. Also, when an N+1^{th} rank is lowest in rank, a final rank index of an N+1^{th} ranked advertisement listing may be determined as a value equal to an initial rank index of the N+1^{th} ranked advertisement listing. That is, because a final rank index of an advertisement listing for bid management is determined based on a final rank index of a next-ranked advertisement listing, the final rank index of the advertisement listing for bid management may be reduced, when compared with an advertisement listing not for bid management.

Referring to FIG. 5, a final rank index c₅′ of an advertisement listing 5 may be determined using a final rank index c₆ of an advertisement listing 6. For example, c₅′ may be a value obtained by adding a predetermined value to c₆. In this instance, because the advertisement listing 6 is lowest in rank, the final rank index c₆ of the advertisement listing 6 may be determined as a value equal to an initial rank index c₆ of the advertisement listing 6.

Also, as bid management on/off information of an advertisement listing 3 is OFF, a final rank index c₃ of the advertisement listing 3 may be determined as a value equal to an initial rank index c₃ of the advertisement listing 3 regardless of a final rank index c₄′ of an advertisement listing 4. Also, a final rank index of an advertisement listing determined not to be displayed may be determined.

Also, the bid management system 101 may determine a final bid amount a₄′ of an advertisement listing 4 by applying a quality index b₄ of the advertisement listing 4 to a final bid amount c₅′ of the advertisement listing 5. In this instance, a final bid amount K of the advertisement listing 6 may be determined as a predetermined amount set in advance. For example, the final bid amount K of the advertisement listing 6 may be determined based on an initial bid amount of a highest-ranked advertisement listing among advertisement listings not displayed due to the number of inventories of a search result page for a keyword. On the whole, a final bid amount of an advertisement listing may be adjusted within an initial bid amount of the advertisement listing. That is, the initial bid amount may be an upper limit, within which the final bid amount may be adjusted. Hence, according to an embodiment of the present invention, a final bid amount may be determined based on an initial bid amount set by an advertiser and the final bid amount may be adjusted to a minimum amount depending on bidding situations.

The values of FIG. 5 may not be fixed. That is, when a new advertisement listing is requested for bidding, there may be a change in whether to display an advertisement listing, and a display rank, a final rank index, and a final bid amount of the advertisement listing. In conclusion, a final bid amount of an advertisement listing, to which the bid management method according to an embodiment of the present invention is applied, may be reduced, when compared with an advertisement listing to which the bid management method according to an embodiment of the present invention is not applied.

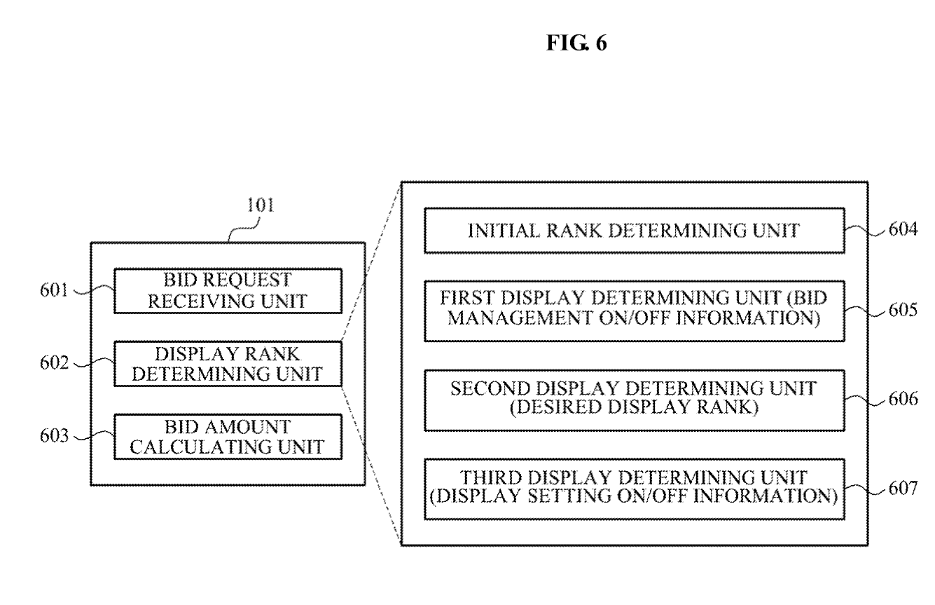

FIG. 6 is a block diagram illustrating the whole structure of a bid management system 101 according to an embodiment of the present invention.

Referring to FIG. 6, the bid management system 101 according to an embodiment of the present invention may include a bid request receiving unit 601, a display rank determining unit 602, and a bid amount calculating unit 603.

The bid request receiving unit 601 may receive a bid request including bid attribute information of an advertisement listing.

For example, the bid attribute information may include (1) an initial bid amount, (2) a desired display rank, (3) bid management on/off information, and (4) display setting on/off information. In this instance, the bid management on/off information may denote information for determining whether an advertisement listing is a target for bid management. Also, the display setting on/off information may represent information for determining whether to display an advertisement listing based on whether a display rank of the advertisement listing meets a desired display rank of the advertisement listing.

The display rank determining unit 602 may determine a display rank of an advertisement listing using bit attribute information. The display rank determining unit 602 may determine both whether to display an advertisement listing and a display rank of the advertisement listing.

Referring to FIG. 6, the display rank determining unit 602 may include an initial rank determining unit 604, a first display determining unit 605, a second display determining unit 606, and a third display determining unit 607. In this instance, the display rank determining unit 602 may determine whether to display an advertisement listing and a display rank of the advertisement listing, using at least one of the first display determining unit 605, the second display determining unit 606, and the third display determining unit 607.

The initial rank determining unit 604 may determine an initial rank of an advertisement using an initial rank index based on a bid amount. In this instance, the initial rank determining unit 604 may determine an initial rank by arranging an initial rank index based on an initial bid amount and a quality index.

The first display determining unit 605 may determine whether to display an advertisement listing using bid management on/off information. In this instance, when bid management on/off information of an advertisement listing is OFF, the first display determining unit 605 may determine the advertisement listing as a target to be displayed.

The second display determining unit 606 may determine whether to display an advertisement listing using an initial rank and a desired display rank. In this instance, when an initial rank of an advertisement listing of which bid management on/off information is ON meets a desired display rank of the advertisement listing, the second display determining unit 606 may determine the advertisement listing as a target to be displayed.

The third display determining unit 607 may determine whether to display an advertisement listing using display setting on/off information. In this instance, when display setting on/off information of an advertisement listing of which bid management on/off information is OFF is OFF, the third display determining unit 607 may determine the advertisement listing not to be displayed.

Also, when display setting on/off information of an advertisement listing of which bid management on/off information is OFF is ON, the third display determining unit 607 may determine the advertisement listing as a target to be displayed.

In this instance, the display rank determining unit 602 may determine a display rank of an advertisement listing determined to be displayed based on an initial rank, by taking into consideration an advertisement listing determined not to be displayed.

The bid amount calculating unit 603 may calculate a final bid amount of an advertisement listing based on a display rank of the advertisement listing. For example, the bid amount calculating unit 603 may calculate a final bid amount of an N^{th} ranked advertisement listing by applying a quality index of the N^{th} ranked advertisement listing to a final rank index of an N+1^{th} ranked advertisement listing.

In this instance, the bid amount calculating unit 603 may calculate a final bid amount in an ascending order of display rank.

In this instance, a final rank index of an N+1^{th} ranked advertisement listing may be determined based on bid management on/off information of the N+1^{th} ranked advertisement listing. Specifically, a final rank index of an N+1^{th} ranked advertisement listing of which bid management on/off information is ON may be determined based on a final rank index of an N+2^{th} ranked advertisement listing. Also, a final rank index of an N+1^{th} ranked advertisement listing of which bid management on/off information is OFF may be determined as a value equal to an initial rank index of the N+1^{th} ranked advertisement listing.

When an N+1^{th} rank is lowest in rank, a final rank index of an N+1^{th} ranked advertisement listing may be determined as a value equal to an initial rank index of the N+1^{th} ranked advertisement listing.

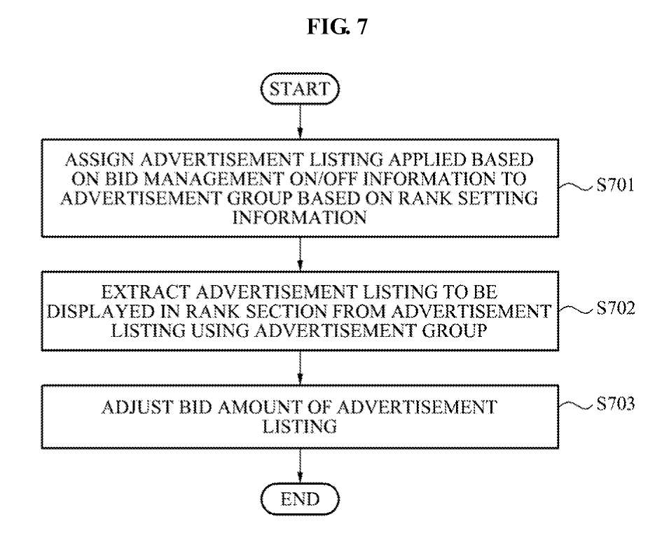

FIG. 7 is a flowchart illustrating a bid management method according to another embodiment of the present invention.

The bid management method of FIG. 7 may be characterized in that a final bid amount of a keyword advertisement may be automatically adjusted within an initial bid amount of the advertisement set by an advertiser, and the final bid amount of the advertisement may be adjusted to a minimum amount in a predetermined rank section.

In operation S701, the bid management system may assign an advertisement listing to an advertisement group based on rank setting information. In this instance, the bid management system may assign an advertisement listing to an advertisement group based on rank setting information including bid management on/off information, a desired display rank, or display setting on/off information.

In this instance, the desired display rank may represent a minimum display rank set by an adviser. When a desired display rank set by an adviser is a 3^{rd} rank or higher, an advertisement listing having a display rank determined as a 4^{th} rank or lower may not be displayed on a search result.

For example, as shown in Table 1, an advertisement listing may be assigned to an advertisement group based on rank setting information. The Table 1 shows an example of an advertisement group based on rank setting information when a displayable rank indicating an inventory of an advertisement listing to be displayed is a 7^{th} rank.

TABLE 1

| | Advertisement | Advertisement | Advertisement | Advertisement | Advertisement |
|---|---|---|---|---|---|
| | group A | group B | group C | group D | group E |
| Bid | On | On | On | Off | Off |
| management | | | | | |
| on/off | | | | | |
| information | | | | | |
| Desired display | 3^{rd} rank or | 5^{th} rank or | 7^{th} rank or | — | — |
| rank | higher | higher | higher | | |
| Display setting | On/Off | Off | On | On | Off |
| on/off | | | | | |
| information | | | | | |

Referring to Table 1, when a desired display rank of an advertisement listing assigned to an advertisement group A is determined as a 3^{rd} rank or higher, the advertisement listing may be displayed on a search result, when a desired display rank of an advertisement listing assigned to an advertisement group B is determined as a 5^{th} rank or higher, the advertisement listing may be displayed on a search result, and when a desired display rank of an advertisement listing assigned to an advertisement group C is determined as a 7^{th} rank or higher, the advertisement listing may be displayed on a search result. Also, an advertisement listing assigned to an advertisement group D may be displayed on a search result regardless of a desired display rank of the advertisement listing, and when a desired display rank of an advertisement listing assigned to an advertisement group E is determined as a 1^{st} rank, the advertisement listing may be displayed on a search result. Table 1 is given by way of illustration only, and the advertisement groups may be changed depending on system conditions.

In operation S702, the bid management system may extract an advertisement listing to be displayed in a rank section from the advertisement listing using the advertisement group. In this instance, the rank section may correspond to the advertisement group, and may be at least one. Also, the rank section may be determined based on rank setting information of an advertisement listing for bid management. For example, the rank section may be determined based on a desired display rank and display setting on/off information of an advertisement listing for bid management.

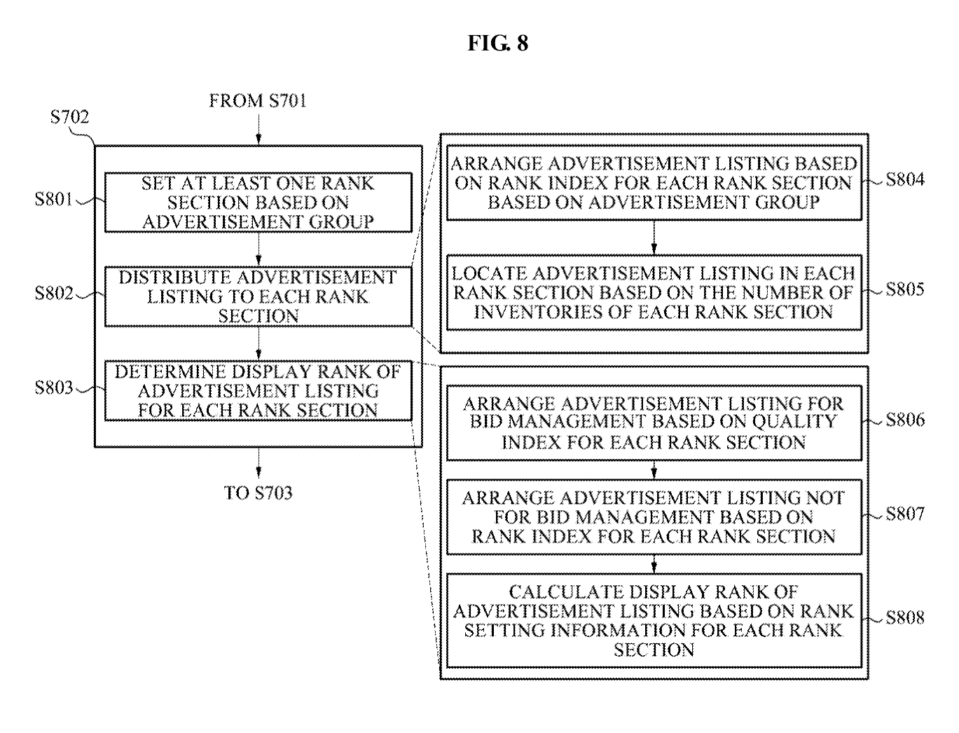

For example, referring to Table 1, the rank section may be determined into a group of first to third ranks, a group of fourth to fifth ranks, and a group of sixth to seventh ranks. The bid management system may extract an advertisement listing to be displayed for each rank section determined, and may determine a display rank of the extracted advertisement listing. The operation S702 is described below in more detail with reference to FIG. 8.

In operation S703, the bid management system may adjust a bid amount of the advertisement listing. In this instance, the bid management system may adjust a bid amount of an advertisement listing for bid management. Specifically, the bid management system may determine a final bid amount of an advertisement listing by adjust an initial bid amount of the advertisement listing set by an advertiser.

In this instance, a final bid amount of an advertisement listing for bid management may be adjusted within, as an upper limit, an initial bid amount of the advertisement listing set by an advertiser when the advertiser requests for bid. Also, the final bid amount of the advertisement listing for bid management may be determined as a minimum amount to maintain a desired display rank of the advertisement listing for each rank section within an initial bid amount of the advertisement listing. However, an advertisement listing not for bid management may be used to determine a display rank of an advertisement listing for bid management, and a final bid amount of the advertisement listing not for bid management may not be adjusted.

For example, the bid management system may adjust a final bid amount of an advertisement listing for bid management using an initial rank index of a next-ranked advertisement listing in a rank section to which the corresponding advertisement listing belongs. Also, the bid management system may determine a final bid amount of an advertisement listing not for bid management as an initial bid amount of the corresponding advertisement listing set by an advertiser when the advertiser requests for bid.

FIG. 8 is a block diagram illustrating a process for extracting an advertisement listing to be displayed in a rank section according to another embodiment of the present invention.

In operation S702, the bid management system may extract an advertisement listing to be displayed in each rank section from an advertisement listing using an advertisement group. As shown in FIG. 8, the operation S702 may include operations S801, S802, and S803.

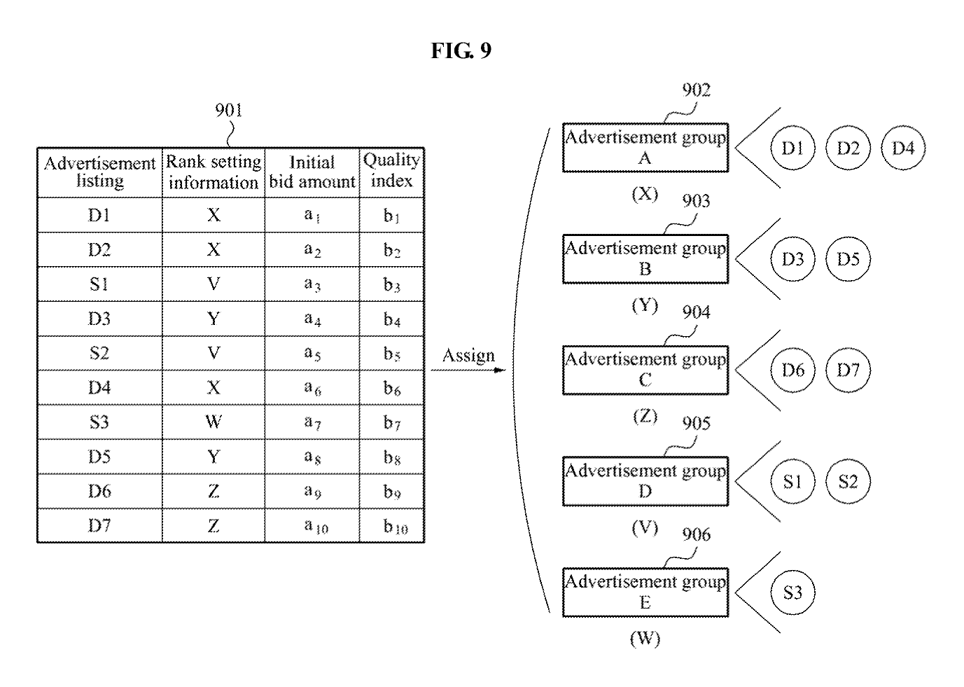

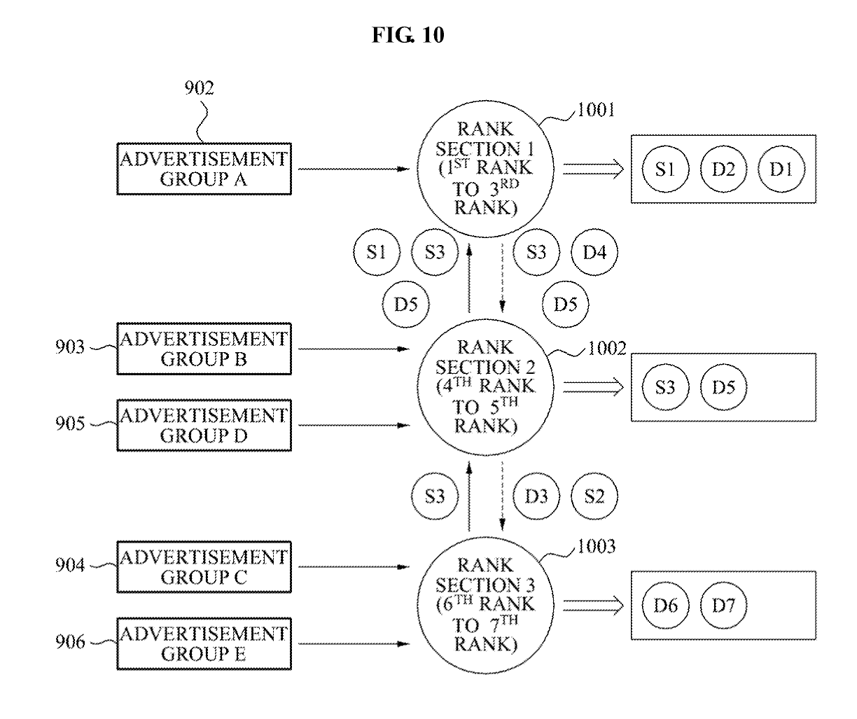

In operation S801, the bid management system may set at least one rank section based on the advertisement group. In this instance, the advertisement group may be determined based on rank setting information of each advertisement listing. Also, the rank setting information may include bid management on/off information, a desired display rank, or display setting on/off information. The relationship between the advertisement group and the rank section is described in more detail with reference to FIGS. 9 and 10.

In operation S802, the bid management system may distribute an advertisement listing to each rank section. That is, the bid management system may perform an interval arithmetic operation on an advertisement listing for each rank section. In this instance, the bid management system may distribute an advertisement listing to each rank section in an ascending order of rank section.

Referring to FIG. 8, the operation S802 may include operations S804 and S805.

In operation S804, the bid management system may arrange an advertisement listing based on an initial rank index for each rank section based on the advertisement group. In this instance, an advertisement listing having a higher initial rank index may be ranked higher in a rank section. Here, the initial rank index may be determined based on an initial bid amount and a quality index. For example, the initial rank index may be determined by multiplying an initial bid amount by a quality index.

In this instance, the quality index may be an index indicating the quality of an advertisement listing, and may be determined by weighting a quality factor as a pre-evaluation factor of the advertisement listing and CTR as a post evaluation factor, respectively.

In operation S805, the bid management system may locate an advertisement listing in each rank section based on the number of inventories of each rank section. In this instance, the bid management system may locate an advertisement listing by comparing the number of inventories of each rank section with the number of advertisement listings in each advertisement group corresponding to each rank section.

In operation S803, the bid management system may determine a display rank of an advertisement listing for each rank section. As shown in FIG. 8, the operation S803 may include operations S806, S807, and S808.

In operation S806, the bid management system may arrange an advertisement listing for bid management based on a quality index for each rank section.

In operation S807, the bid management system may arrange an advertisement listing not for bid management based on an initial rank index for each rank section.

In operation S808, the bid management system may calculate a display rank of an advertisement listing based on rank setting information for each rank section. In this instance, the bid management system may calculate a display rank of an advertisement listing not for bid management higher than that of an advertisement listing for bid management for each rank section. Also, the bid management system may determine, for each rank section, a display rank of an advertisement listing not for bid management based on an initial rank index, and then may determine a display rank of an advertisement listing for bid management based on a quality index.

Also, the bid management system may determine a display rank of an advertisement listing based on the number of inventories of each rank section. Also, the bid management system may determine a display rank of an advertisement listing for each rank section in a descending order of rank section. The display rank determined through the above-described operations may be temporarily determined, and may be changed after determining whether to display an advertisement listing based on rank setting information.

However, when a display rank of an advertisement listing is determined for each rank section, whether or not the advertisement listing is displayed may be determined based on rank setting information. For example, when a desired display rank of an advertisement listing having a display rank determined as a 4^{th} rank is an 8^{th} rank or lower, the corresponding advertisement listing may not be displayed on a search result.

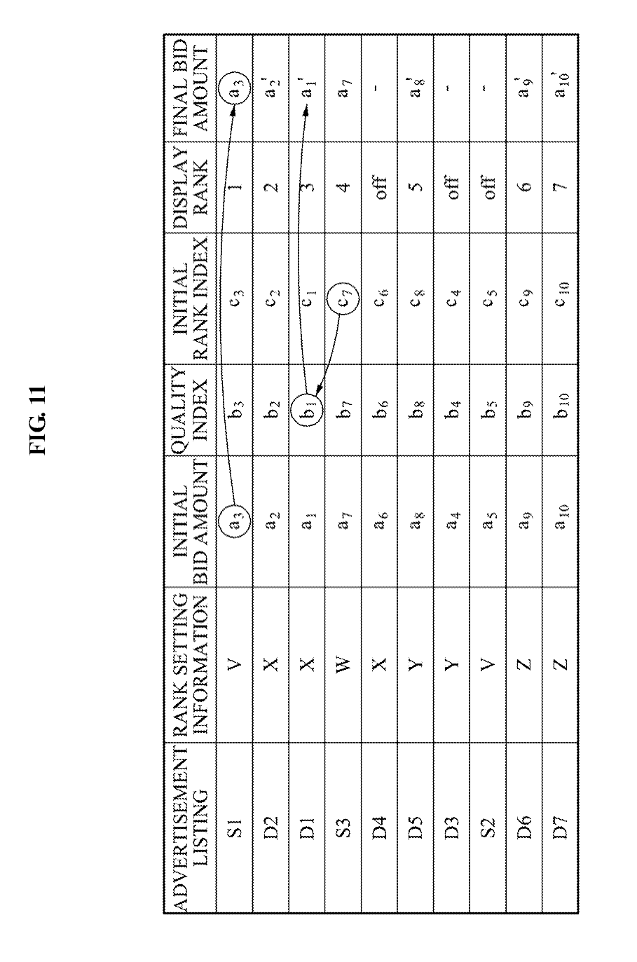

Hereinafter, an example, to which the method of FIGS. 7 and 8 is applied, is described below with regard to FIGS. 9 and 11.

FIG. 9 is a view illustrating an example of sorting advertisement listings requested for bidding into advertisement groups based on rank setting information according to another embodiment of the present invention.

FIG. 9 shows a plurality of advertisement listings 901 requested for bidding to the bid management system. As shown in FIG. 9, the advertisement listings 901 may include an advertisement listing for bid management or an advertisement listing not for bid management. In the advertisement listings 901, an advertisement listing for bid management may be indicated as D and an advertisement listing not for bid management may be indicated as S.

Also, rank setting information, an initial bid amount, and a quality index of the advertisement listing requested for bidding may be set. The quality index may be determined by weighting a quality factor as a pre-evaluation factor and CTR as a post evaluation factor, respectively.

In this instance, the initial bid amount may refer to an upper limit of a final bid amount of an advertisement listing for bid management, the final bid amount being adjusted through the bid management system. That is, a final bid amount of an advertisement listing for bid management may not exceed an initial bid amount of the corresponding advertisement listing. Also, the final bid amount may be determined as a minimum amount in a range that meets a rank section within the initial bid amount.

As described above, the rank setting information may include bid management on/off information, a desired display rank, or display setting on/off information. An example of the rank setting information is shown above in Table 1.

For example, the bid management system according to another embodiment of the present invention may assign an advertisement listing to an advertisement group based on rank setting information. Referring to the advertisement listings 901, an advertisement listing for bid management may be set as rank setting information X, Y, or Z, and an advertisement listing not for bid management may be set as rank setting information V or W.

Referring to FIG. 9, advertisement listings D1, D2, and D4 of which rank setting information is X may be assigned to an advertisement group A 902. Also, advertisement listings D3 and D5 of which rank setting information is Y may be assigned to an advertisement group B 903. Also, advertisement listings D6 and D7 of which rank setting information is Z may be assigned to an advertisement group C 904. Advertisement listings S1 and S2 of which rank setting information is V may be assigned to an advertisement group D 905. Also, an advertisement listing S3 of which rank setting information is W may be assigned to an advertisement group E 906.

FIG. 10 is a view illustrating an example of extracting an advertisement listing to be displayed in each rank section from advertisement listings requested for bidding according to another embodiment of the present invention.

FIG. 10 is described based on the advertisement listings 901 of FIG. 9. For example, the advertisement listings 901 may be set as shown in Table 2. In the present invention, the values set to each advertisement listing in Table 2 are given by way of illustration only, and may be changed depending on situations.

TABLE 2

| Advertisement | | Initial bid | Quality |
|---|---|---|---|
| listing | Rank setting information | amount | index |
| D1 | X (3^{rd} rank or higher) | 500 | 6 |
| D2 | X (3^{rd} rank or higher) | 400 | 7 |
| S1 | V (off) | 600 | 6 |
| D3 | Y (5^{th} rank or higher) | 300 | 3 |
| S2 | V (off) | 200 | 4 |
| D4 | X (3^{rd} rank or higher) | 250 | 5 |
| D5 | Y (5^{th} rank or higher) | 250 | 4 |
| S3 | W (on) | 350 | 6 |
| D6 | Z (7^{th} rank or higher) | 200 | 4 |
| D7 | Z (7^{th} rank or higher) | 250 | 3 |

As shown in Table 2, the advertisement listings D1, D2, and D4 for bid management, of which rank setting information is X, may be assigned to the advertisement group A 902. Also, the advertisement listings D3 and D5 for bid management, of which rank setting information is Y, may be assigned to the advertisement group B 903. Also, the advertisement listings D6 and D7 for bid management, of which rank setting information is Z, may be assigned to the advertisement group C 904. The advertisement listings S1 and S2 not for bid management, of which rank setting information is V, may be assigned to the advertisement group D 905. Also, the advertisement listing S3 not for bid management, of which rank setting information is W, may be assigned to the advertisement group E 906.

The bid management system according to another embodiment of the present invention may distribute an advertisement listing to each rank section, in operation S802. The bid management system may determine a display rank of the advertisement listing for each rank section, in operation S803.

In this instance, the bid management system may arrange the advertisement listing based on an initial rank index for each rank section based on the advertisement group, in operation S804. The initial rank index may be determined as a combination of an initial bid amount and a quality index. Also, the bid management system may locate the advertisement listing in each rank section based on the number of inventories of each rank section, in operation S805.

For example, referring to FIG. 10, the bid management system may arrange the advertisement listings D6 and D7 assigned to the advertisement group C 904 and the advertisement listing S3 assigned to the advertisement group E 906, based on an initial rank index. Referring to Table 2, the advertisement listings in the rank section 3 1003 may be arranged in the order of an initial rank index, such as S3, D6, and D7. Also, as the number of inventories of the rank section 3 1003 is two, that is, a 6^{th} rank and a 7^{th} rank, the bid management system may move the advertisement listing S3 to the rank section 2 1002, except the two lowest-ranked advertisement listings D6 and D7 in the rank section 3 1003, based on an initial rank index.

Also, the bid management system may arrange the advertisement listings D3 and D5 assigned to the advertisement group B 903, the advertisement listings S1 and S2 assigned to the advertisement group D 905, and the advertisement listing S3 moved from the rank section 3 1003. Referring to Table 2, the advertisement listings in the rank section 2 1002 may be arranged in the order of an initial rank index, such as S1, S3, D5, D3, and S2. Also, as the number of inventories of the rank section 2 1002 is two, that is, a 4^{th} rank and a 5^{th} rank, the bid management system may move the advertisement listings S1, S3, and D5 to the rank section 1 1001, except the two lowest-ranked advertisement listings D3 and S2 in the rank section 2 1002.

Also, the bid management system may arrange the advertisement listings D1, D2, and D4 assigned to the advertisement group A 902, and the advertisement listings S1, S3, and D5 moved from the rank section 2 1002, based on an initial rank index. Referring to Table 2, the advertisement listings in the rank section 1 1001 may be arranged in the order of an initial rank index, such as S1, D2, D1, S3, D4, and D5. In this instance, as the number of inventories of the rank section 1 1001 is three, that is, a 1^{st} rank, a 2^{nd} rank, and a 3^{rd} rank, the bid management system may move the advertisement listings S3, D4, and D5 to the rank section 2 1002, except the three highest-ranked advertisement listings S1, D2, and D1 in the rank section 1 1001.

That is, the bid management system may locate an advertisement listing in each rank section in an ascending order of rank section.

For example, the bid management system may arrange an advertisement listing for bid management based on a quality index for each rank section, in operation S806. Also, the bid management system may arrange an advertisement listing not for bid management based on a rank index for each rank section, in operation S807. Then, the bid management system may calculate a display rank of each advertisement listing based on rank setting information for each rank section, in operation S808. In this instance, the bid management system may calculate, for each rank section, a display rank of an advertisement listing not for bid management higher than a display rank of an advertisement listing for bid management.

With regard to the rank section 1 1001, the bid management system may arrange the advertisement listing S1 not for bid management based on an initial rank index, and may arrange the advertisement listings D2 and D1 for bid management based on a quality index. Also, as a display rank of an advertisement listing not for bid management is prior to that of an advertisement listing for bid management, display ranks of the advertisement listings in the rank section 1 1001 may be determined in the order of S1, D2, and D1.

Also, with regard to the rank section 2 1002, the bid management system may arrange the advertisement listings D3 and S2 located in the rank section 2 1002 and the advertisement listings S3, D4, and D5 moved from the rank section 1 1001, based on an initial rank index. Referring to Table 2, the advertisement listings in the rank section 2 1002 may be arranged in the order of S3, D4, D5, D3, and S2.

In this instance, with regard to the rank section 2 1002, the bid management system may determine the two highest-ranked advertisement listings S3 and D4 as advertisement listings to be displayed in the rank section 2 1002. However, because a desired display rank of the advertisement listing D4 is a 3^{rd} rank or higher, the advertisement listing D4 may not be displayed when a display rank of the advertisement listing D4 is determined as a 5^{th} rank. Accordingly, the advertisement listing D4 may not be displayed in the rank section 2 1002, and the bid management system may determine the next-ranked advertisement listing D5 as an advertisement listing to be displayed in the rank section 2 1002. Finally, advertisement listings to be displayed in the rank section 2 1002 may be determined as S3 and D5. The advertisement listings D3 and S2 determined not to be displayed in the rank section 2 1002 may be moved to the rank section 3 1003.

Also, with regard to the rank section 3 1003, the bid management system may arrange the advertisement listings D6 and D7 located in the rank section 3 1003 and the advertisement listings D3 and S2 moved from the rank section 2 1002, based on an initial rank index. Referring to Table 2, the advertisement listings in the rank section 3 1003 may be arranged in the order of D3, S2, D6, and D7.

For example, the bid management system may determine whether to display an advertisement listing for bid management based on a desired display rank, and may determine whether to display an advertisement listing not for bid management based on display setting on/off information. That is, because the advertisement listing D3 belongs to the rank section 3 1003, that is, a display rank of the advertisement listing D3 is determined lower than a 5^{th} rank, the advertisement listing D3 may not be displayed based on a desired display rank. As rank setting information of the advertisement listing S2 is OFF and a display rank of the advertisement listing S2 is not determined as a 1^{st} rank, the advertisement listing S2 may not be displayed on a search result. Accordingly, the bid management system may determine the display ranks of the advertisement listings in the rank section 3 1003 by arranging the advertisement listings D6 and D7 for bid management based on a quality index, except the advertisement listings D3 and S2 determined not to be displayed. Accordingly, advertisement listings to be displayed in the rank section 3 1003 may be determined as D6 and D7.

Referring to FIG. 10, the advertisement listings to be finally displayed on a search result may be S1, D2, D1, S3, D5, D6, and D7 based on a display rank. An example of FIG. 10 is given by way of illustration only, and whether to display an advertisement listing requested for bidding and a display rank of the advertisement listing in a rank section may be determined based on an initial bid amount, a quality index, and rank setting information of the corresponding advertisement listing.

FIG. 11 is a chart illustrating a bid management result obtained by applying the bid management method to an advertisement listing for bid management and an advertisement listing not for bid management, according to another embodiment of the present invention.

Referring to FIG. 11, a result obtained by performing the process of FIGS. 7 and 8 on Table 1 is illustrated. That is, the advertisement listings in the rank section 1 may be displayed in the order of S1, D2, and D1, advertisement listings in the rank section 2 may be displayed in the order of S3 and D5, and the advertisement listings in the rank section 3 may be displayed in the order of D6 and D7. The advertisement listings D4, D3, and S2 may not be displayed on a keyword search result based on rank setting information.

For example, the bid management system may adjust a bid amount of each advertisement listing to be displayed. In this instance, when an advertisement listing to be displayed is a target for bid management, the bid management system may determine a final bid amount of the advertisement listing by adjusting an initial bid amount of the advertisement listing using a rank index of a next-ranked advertisement listing in a rank section to which the advertisement listing belongs. Also, when an advertisement listing to be displayed is not a target for bid management, the bid management system may maintain a final bid amount of the advertisement listing equal to an initial bid amount of the advertisement listing set when requesting a bid.

Specifically, the bid management system may determine a final bid amount of an advertisement listing for bid management by applying a quality index of the advertisement listing to an initial rank index of a next-ranked advertisement listing in a rank section of the advertisement listing.

Referring to Table 2, as the advertisement listings D2 and D1 are advertisement listings to be displayed in the rank section 1, the bid management system may adjust final bid amounts of the advertisement listings D2 and D1 by applying quality indices b₂ and b₁ of D2 and D1 to an initial rank index c₇ of the next-ranked advertisement listing S3 in the rank section 1, respectively. As the advertisement listing S1 is not an advertisement listing for bid management and an initial bid amount of the advertisement listing S1 is not adjusted, a final bid amount of the advertisement listing S1 may be determined as a value equal to an initial bid amount of the advertisement listing S1.

In the same way, as the advertisement listing D5 is an advertisement listing to be displayed in the rank section 2, the bid management system may adjust a final bid amount of the advertisement listing D5 by applying a quality index b₆ of the advertisement listing D5 to an initial rank index c₄ of the next-ranked advertisement listing D3 in the rank section 2. In this instance, the advertisement listing D3 actually belongs to the rank section 3, and does not belong to and is not displayed in the rank section 2, but the advertisement listing D3 may be used to determine a final bid amount of the advertisement listing D5.

Also, because the advertisement listings D6 and D7 are advertisement listings to be displayed in the rank section 3, and a rank section next to the rank section 3 does not exist, a final bid amount of each of the advertisement listings D6 and D7 may be determined as a predetermined minimum bid amount set in advance. A final bid amount of an advertisement listing for bid management adjusted through the bid management system may be, for each rank section, determined as a minimum amount within an initial bid amount of the corresponding advertisement listing set by an adviser when the advertiser requests for bid.

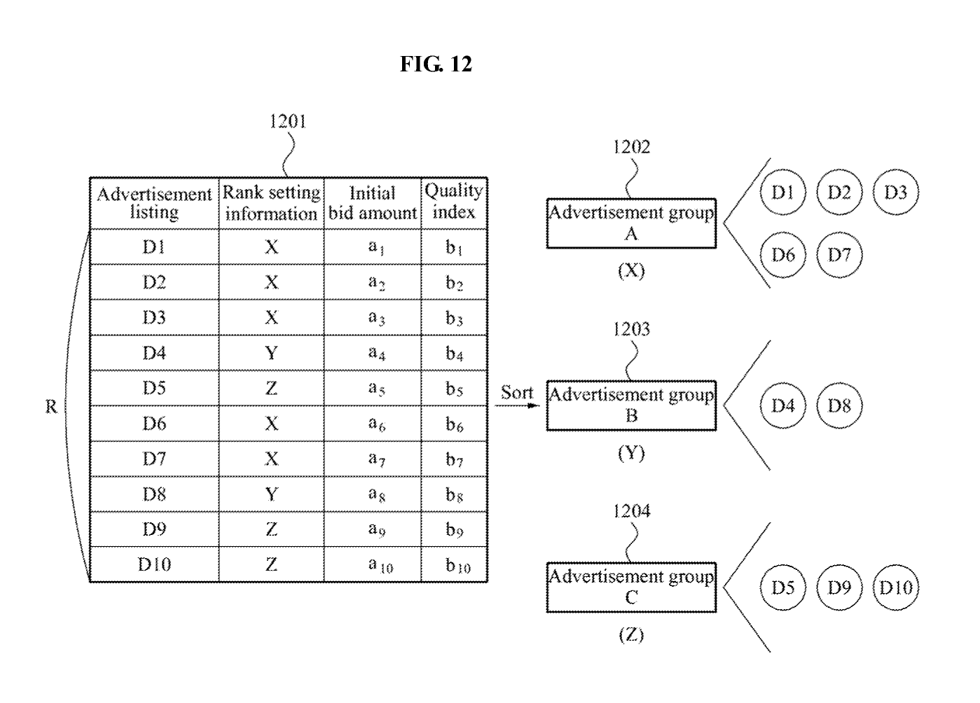

FIG. 12 is a view illustrating an example of sorting advertisement listings for bid management into advertisement groups based on rank setting information according to another embodiment of the present invention.

FIG. 12 illustrates a table 1201 including a plurality of advertisement listings requested for bidding to the bid management system. As shown in FIG. 12, the advertisement listings requested for bidding are a total of 10 (R) advertisement listings D1 to D10. FIG. 12 shows an example including only advertisement listings for bid management, as opposed to FIG. 9.

Also, rank setting information, an initial bid amount, and a quality index of each of the advertisement listings requested for bidding may be set. As described above, the rank setting information may include bid management on/off information, a desired display rank, or display setting on/off information. In this instance, because FIG. 12 is only for an advertisement listing for bid management, bid management on/off information may be excluded from rank setting information. An example of rank setting information is described above with reference to Table 1.

Also, an initial bid amount may stand for an upper limit of a final bid amount of an advertisement listing for bid management. That is, a final bid amount calculated through the bid management system may not exceed an initial bid amount. Also, a quality index may be determined by weighting a quality factor as a pre-evaluation factor and CTR as a post evaluation factor, respectively. For example, the initial bid amount may be a value set by an advertiser, and the quality index may be a value determined through a variety of advertisement measuring elements.

For example, the bid management system according to another embodiment of the present invention may sort an advertisement listing into an advertisement group based on rank setting information. Referring to the advertisement listings 1201, rank setting information of an advertisement listing may be set as X, Y, or Z.

Referring to FIG. 12, advertisement listings D1, D2, D3, D6, and D7, of rank setting information is X, may be sorted into an advertisement group A 1202. Also, advertisement listings D4, and D8, of rank setting information is Y, may be sorted into an advertisement group B 1203. Also, advertisement listings D5, D9, and D10, of rank setting information is Z, may be sorted into an advertisement group C 1204.

The bid management system according to an embodiment of the present invention may sort an advertisement listing into an advertisement group based on rank setting information, thereby efficiently managing an advertisement listing requested for bidding.

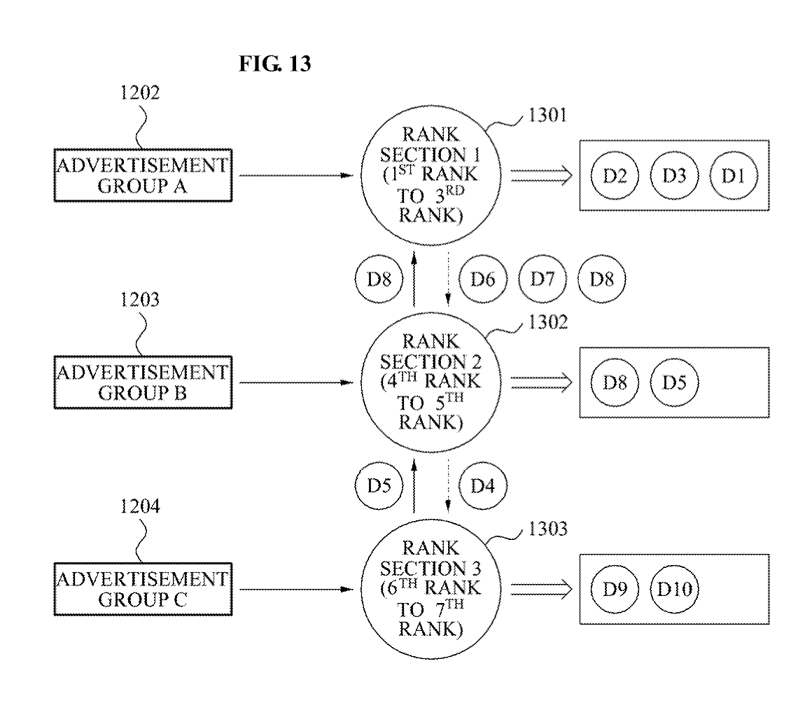

FIG. 13 is a view illustrating a process for determining an advertisement listing to be displayed in each rank section from advertisement listings requested for bidding according to another embodiment of the present invention.

FIG. 13 is described based on a table 1201 of FIG. 12. For example, the advertisement listings included in the table 1201 may be set as shown in Table 3 below. In the present invention, the values set for each advertisement listing in Table 3 are given by way of illustration only, and may be changed depending on conditions.

TABLE 3

| Advertisement | | Initial bid | Quality |
|---|---|---|---|
| listing | Rank setting information | amount | index |
| D1 | X (3^{rd} rank or higher) | 500 | 6 |
| D2 | X (3^{rd} rank or higher) | 400 | 7 |
| D3 | X (3^{rd} rank or higher) | 600 | 6 |
| D4 | Y (5^{th} rank or higher) | 300 | 3 |
| D5 | Z (7^{th} rank or higher) | 200 | 5 |
| D6 | X (3^{rd} rank or higher) | 250 | 5 |
| D7 | X (3^{rd} rank or higher) | 350 | 6 |
| D8 | Y (5^{th} rank or higher) | 250 | 5 |
| D9 | Z (7^{th} rank or higher) | 150 | 4 |
| D10 | Z (7^{th} rank or higher) | 250 | 3 |

As described above in FIG. 12, the advertisement listings D1, D2, D3, D6, and D7, of rank setting information is X, may be sorted into the advertisement group A 1202. Also, the advertisement listings D4 and D8, of rank setting information is Y, may be sorted into the advertisement group B 1203. Also, the advertisement listings D5, D9, and D10, of rank setting information is Z, may be sorted into the advertisement group C 1204.

The bid management system according to an embodiment of the present invention may extract an advertisement listing to be displayed in each rank section from an advertisement listing using an advertisement group, in operation S702.

In this instance, the bid management system may set at least one rank section based on an advertisement group, in operation S801. Referring to Table 3, because rank setting information X is a 3^{rd} rank or higher, rank setting information Y is a 5^{th} rank or higher, and rank setting information Z is a 7^{th} rank or higher, the bid management system may set a rank section 1 1301 for 1^{st} to 3^{rd} ranked advertisement listings to be displayed, a rank section 2 1302 for 4^{th} to 5^{th} ranked advertisement listings to be displayed, and a rank section 3 1303 for 6^{th} to 7^{th} ranked advertisement listings to be displayed, based on rank setting information.

That is, when a display rank of an advertisement listing is determined lower than a 7^{th} rank, the advertisement listing may not be displayed on a search result because the advertisement listing does not belong to a rank section. The rank setting information of Table 3 is given by way of illustration only.

In this instance, the bid management system may distribute an advertisement listing to each rank section, in operation S802. For example, the bid management system may arrange an advertisement listing based on an initial rank index for each rank section based on an advertisement group. Also, the bid management system may locate an advertisement listing in each rank section based on the number of inventories of each rank section.

As shown in FIG. 13, the advertisement listings may be distributed to each rank section in an ascending order of rank section. That is, the bid management system may perform an interval arithmetic operation for each rank section in the order of a rank section 3 1303, a rank section 2 1302, and a rank section 1 1301.

The bid management system may arrange the advertisement listings D5, D9, and D10 in the advertisement group C 1204 based on an initial rank index. In this instance, the initial rank index may be determined by multiplying an initial bid amount by a quality index.

Referring to Table 2, the bid management system may arrange the advertisement listings of the advertisement group C 1204 in the order of D5, D9, and D10. However, as the number of inventories of the rank section 3 1303 is two, the advertisement listing D5 may be moved to the rank section 2 1302, except the two lowest-ranked advertisement listings D9 and D10 in the advertisement group C 1204.

The bid management system may distribute the advertisement listings to the rank section 2 1302 and the rank section 1 1301, respectively, in the same way as the rank section 3 1303. The bid management system may distribute, to the rank section 2 1302, the advertisement listing assigned to the advertisement group B 1203 and the advertisement listing moved from the rank section 3 1303.

The bid management system may arrange the advertisement listings D4, D5, and D8 in the rank section 2 1302 based on an initial rank index. Also, the bid management system may locate two lowest-ranked advertisement listings among the arranged advertisement listings in the rank section 2 1302 based on the number of inventories of the rank section 2 1302, and may move the other advertisement listing to the rank section 1 1301. Referring to FIG. 13, the advertisement listings D4 and D5 may be located in the rank section 2 1302, and the advertisement listing D8 may be moved to the rank section 1 1301.

The bid management system may arrange the advertisement listing D8 moved from the rank section 2 1302, and the advertisement listings D1, D2, D3, D6, and D7 assigned to the advertisement group A 1202 in the rank section 1 1301, based on an initial rank index.

Also, by taking into consideration that the number of inventories of the rank section 1 1301 is three, the bid management system may locate the three highest-ranked advertisement listings D1, D2, and D3 in the rank section 1 1301, and may move the advertisement listings D6, D7, and D8 to the rank section 2 1302.

In this instance, the bid management system may arrange the advertisement listings D1, D2, and D3 located in the rank section 1 1301, based on a quality index. In this instance, the advertisement listings in the rank section 1 1301 may be arranged in the order of D2, D3, and D1. Also, because rank setting information of the advertisement listings D2, D3, and D1 is all a 3^{rd} rank or higher, the advertisement listings D2, D3, and D1 may be all displayed on a search result. Finally, advertisement listings to be displayed in the rank section 1 1301 may be determined as D2 (1^{st} rank), D3 (2^{nd} rank), and D1 (3^{rd} rank).

In the same way, the bid management system may arrange the advertisement listings D4 and D5 located in the rank section 2 1302 and the advertisement listings D6, D7, and D8 moved from the rank section 1 1301, based on a quality index. In this instance, because rank setting information of the advertisement listings D6 and D7 is each a 3^{rd} rank or higher, the advertisement listings D6 and D7 may not be displayed on a search result. Accordingly, display ranks of the advertisement listings D4, D5, and D8 may be determined.

By arranging the advertisement listings D4, D5, and D8 based on a quality index, the bid management system may determine the two highest-ranked advertisement listings D5 and D8 as advertisement listings to be the rank section 2 1302 based on the number of inventories of the rank section 2 1302, and may move the advertisement listing D4 to the rank section 3 1303. For example, display ranks of D5 and D8 may be each determined based on a quality index. For example, referring to Table 2, because the advertisement listings D5 and D8 have the same quality index, display ranks of the advertisement listings D5 and D8 may be each determined based on an initial rank index. Finally, advertisement listings to be displayed in the rank section 2 1302 may be determined as D8 (4^{th} rank) and D5 (5^{th} rank).

Also, the bid management system may arrange, in the rank section 3 1303, the advertisement listing D4 moved from the rank section 2 1302 and the advertisement listings D9 and D10 located in the rank section 3 1303, based on a quality index. However, as rank setting information of the advertisement listing D4 is a 5^{th} rank or higher, the advertisement listing D4 may not be displayed, and finally, the advertisement listings D9 and D10 may be determined as advertisement listings to be displayed in the rank section 3 1303. Accordingly, advertisement listings to be displayed in the rank section 3 1303 may be determined as D9 (6^{th} rank) and D10 (7^{th} rank).

Referring to FIG. 13, advertisement listings to be finally displayed may be determined as D2, D3, D1, D8, D5, D9, and D10 based on a display rank.

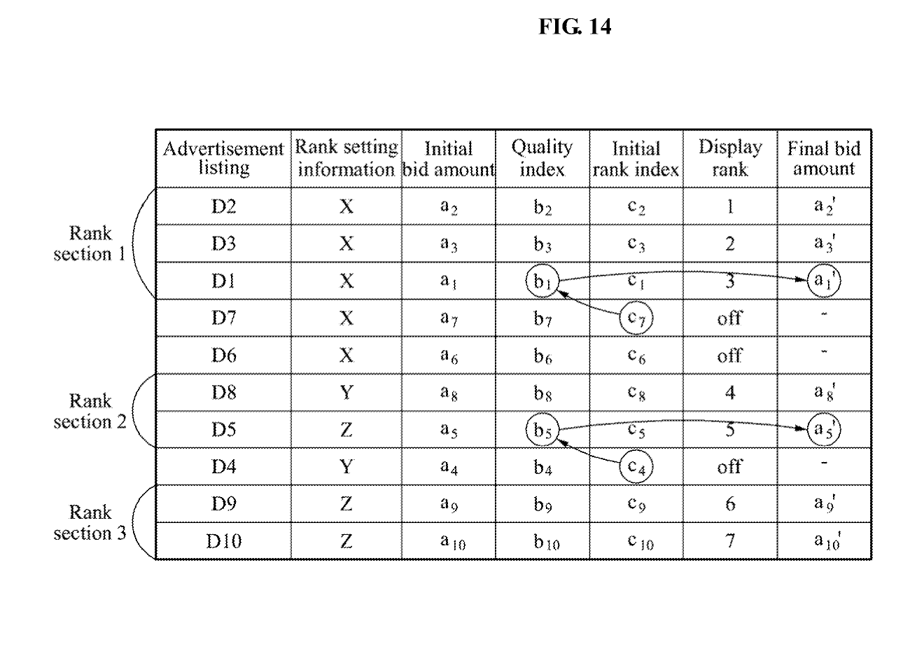

FIG. 14 is a view illustrating a bid management result obtained by applying the bid management method to an advertisement listing for bid management according to another embodiment of the present invention.

Referring to FIG. 14, a result obtained by performing the process of FIGS. 12 and 13 on Table 1 is illustrated. That is, it is found that D2, D3, and D1 are determined as advertisement listings to be displayed in the rank section 1, D8 and D5 are determined as advertisement listings to be displayed in the rank section 2, and D9 and D10 are determined as advertisement listings to be displayed in the rank section 3. The advertisement listings D6, D7, and D4 may not be displayed on a search result based on rank setting information.

For example, the bid management system may adjust a bid amount of an advertisement listing. In this instance, when a display rank of a lowest-ranked advertisement listing in a rank section is an n^{th} rank, the bid management system may calculate a final bid amount of the advertisement listing using an initial rank index of an n+1^{th} ranked advertisement listing in a next rank section. Also, the bid management system may determine a final bid amount of an n^{th} ranked advertisement listing by applying a quality index of the n^{th} ranked advertisement listing to an initial rank index of an n+1^{th} ranked advertisement listing.

In other words, the bid management system may calculate a final bid amount of each of the advertisement listings D2, D3, and D1 to be displayed in the rank section 1 using an initial rank index of the advertisement listing D7. That is, to compensate for an opportunity cost of not falling within the rank section 1, the bid management system may use an initial rank index of the advertisement listing D7, which is not actually displayed in the rank section 1, to calculate a final bid amount of each of the advertisement listings D2, D3, and D1 in the rank section 1. Accordingly, the final bid amount of the advertisement listing D1 may be determined using an initial rank index of the advertisement listing D7 and a quality index of the advertisement listing D1. Also, the final bid amount of the advertisement listing D2 may be determined using an initial rank index of the advertisement listing D7 and a quality index of the advertisement listing D2. However, the final bid amount of the advertisement listing D1 or the advertisement listing D2 may be determined within an initial bid amount of each of the advertisement listings D1 and D2.

In the same way, the bid management system may calculate a final bid amount of each of the advertisement listings D8 and D5 in the rank section 2 by adjusting an initial bid amount of the corresponding advertisement listing using an initial rank index of the advertisement listing D4. However, a final bid amount of each of the advertisement listings D9 and D10 in the lowest rank section, that is, the rank section 3, may be determined as a minimum bid amount set in advance. For example, when a minimum bid amount is 70 won, a final bid amount of each of the advertisement listings D9 and D10 may be determined as 70 won.

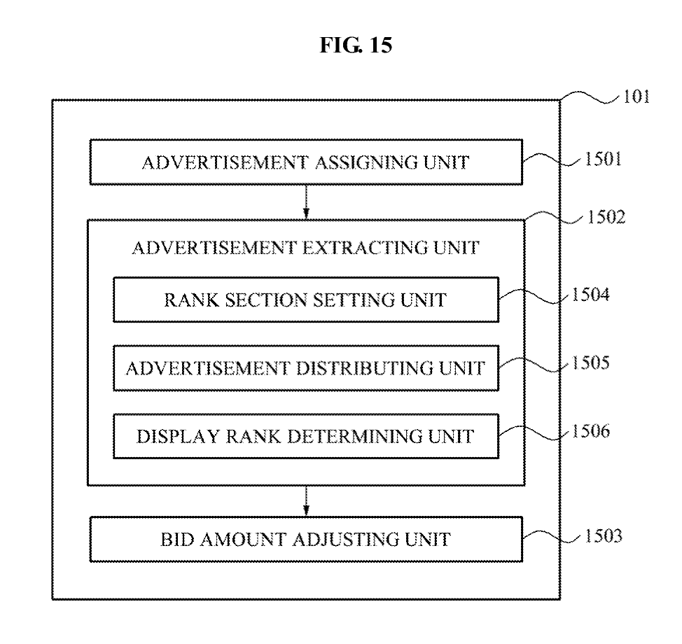

FIG. 15 is a block diagram illustrating the whole structure of a bid management system 101 according to another embodiment of the present invention.

Referring to FIG. 15, the bid management system 101 may include an advertisement assigning unit 1501, an advertisement extracting unit 1502, and a bid amount adjusting unit 1503.

The advertisement assigning unit 1501 may assign an advertisement listing to an advertisement group based on rank setting information. For example, the advertisement assigning unit 1501 may assign an advertisement listing to an advertisement group based on rank setting information including bid management on/off information, a desired display rank, or display setting on/off information.

The advertisement extracting unit 1502 may extract an advertisement listing to be displayed in a rank section from the advertisement listing using the advertisement group. Referring to FIG. 15, the advertisement extracting unit 1502 may include a rank section setting unit 1504, an advertisement distributing unit 1505, and a display rank determining unit 1506.

The rank section setting unit 1504 may set at least one rank section based on the advertisement group.

The advertisement distributing unit 1505 may distribute the advertisement listing to each rank section. For example, the advertisement distributing unit 1505 may arrange an advertisement listing based on an initial rank index for each rank section based on the advertisement group. Also, the advertisement distributing unit 1505 may locate the arranged advertisement listing in each rank section based on the number of inventories of each rank section. In this instance, the advertisement distributing unit 1505 may distribute the advertisement listing to each rank section in an ascending order of rank section.

In this instance, the initial rank section may be determined based on an initial bid amount and a quality index. Also, the quality index may be determined by weighting a quality factor as a pre-evaluation factor and CTR as a post evaluation factor, respectively.

The display rank determining unit 1506 may determine a display rank of the distributed advertisement listing for each rank section. For example, the display rank determining unit 1506 may arrange, for each rank section, an advertisement listing for bid management based on a quality index. Also, the display rank determining unit 1506 may arrange, for each rank section, an advertisement listing not for bid management based on an initial rank index. Also, the display rank determining unit 1506 may determine, for each rank section, a display rank of an advertisement listing based on rank setting information. In this instance, the display rank determining unit 1506 may calculate, for each rank section, a display rank of an advertisement listing not for bid management higher than a display rank of an advertisement listing for bid management.

For example, the display rank determining unit 1506 may determine a display rank of an advertisement listing based on the number of inventories of each rank section. Also, the display rank determining unit 1506 may determine a display rank of an advertisement listing for each rank section in a descending order of advertisement listing.

The bid amount adjusting unit 1503 may adjust a final bid amount of an advertisement listing. For example, when an advertisement listing to be displayed is a target for bid management, the bid amount adjusting unit 1503 may adjust an initial bid amount of the advertisement listing using an initial rank index of a next-ranked advertisement listing in a rank section to which the advertisement listing belongs. As the initial bid amount is adjusted, a final bid amount may be determined, and in this instance, the final bid amount may be determined within the initial bid amount set by an advertiser. Also, when an advertisement listing to be displayed is not a target for bid management, the bid amount adjusting unit 1503 may maintain an initial bid amount of the advertisement listing set when requesting a bid.

In this instance, when an advertisement listing to be displayed is a target for bid management, the bid amount adjusting unit 1503 may adjust an initial bid amount of the advertisement listing by applying a quality index of the advertisement listing to an initial rank index of a next-ranked advertisement listing. Also, a final bid amount may be determined by adjusting the initial bid amount. When an advertisement listing to be displayed is a target for bid management and a rank section is a lowest rank section, the bid amount adjusting unit 1503 may determine a final bid amount of the advertisement listing as a minimum bid amount of the advertisement listing set in advance.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A bid management method comprising:
receiving a bid request including bid attribute information of an advertisement listing;
determining a display rank of the advertisement listing using the bid attribute information; and
calculating a final bid amount of the advertisement listing based on the display rank of the advertisement listing.

2. The method of claim 1, wherein the bid attribute information includes (1) an initial bid amount, (2) a desired display rank, (3) bid management on/off information for determining whether an advertisement listing is a target for bid management, and (4) display setting on/off information for determining whether to display an advertisement listing based on whether a display rank of the advertisement listing meets a desired display rank of the advertisement listing.

3. The method of claim 2, wherein the determining of the display rank of the advertisement listing comprises:
determining an initial rank of the advertisement listing using an initial rank index based on the initial bid amount;
determining whether to display the advertisement listing using the bid management on/off information;
determining whether to display the advertisement listing using the initial rank and the desired display rank; and
determining whether to display the advertisement listing using the display setting on/off information.

4. The method of claim 3, wherein the determining of the initial rank of the advertisement listing using the initial rank index based on the initial bid amount comprises determining the initial rank of the advertisement listing by arranging the initial rank index of the advertisement listing based on the initial bid amount and a quality index of the advertisement listing.

5. The method of claim 4, wherein the determining of whether to display the advertisement listing using the bid management on/off information comprises determining to display the advertisement listing when the bid management on/off information is OFF, and determining whether to display the advertisement listing based on the desired display rank when the bid management on/off information is ON.

6. The method of claim 4, wherein the determining of whether to display the advertisement listing using the initial rank and the desired display rank comprises determining to display the advertisement listing when the initial rank of the advertisement listing meets the desired display rank of the advertisement listing, and determining whether to display the advertisement listing based on the display setting on/off information when the initial rank of the advertisement listing does not meet the desired display rank of the advertisement listing.

7. The method of claim 4, wherein the determining of whether to display the advertisement listing using the display setting on/off information comprises determining not to display the advertisement listing when the display setting on/off information is OFF, and determining the display rank of the advertisement listing by taking into consideration an advertisement listing not displayed, when the display setting on/off information is ON.

8. The method of claim 1, wherein the calculating of the final bid amount of the advertisement listing comprises calculating a final bid amount of an N^{th} advertisement listing by applying a quality index of the N^{th} advertisement listing to an initial rank index of an N+1^{th} ranked advertisement listing.

9. The method of claim 8, wherein the initial rank index of the N+1^{th} ranked advertisement listing is determined based on an initial rank index of an N+2^{th} ranked advertisement listing when bid management on/off information of the N+1^{th} ranked advertisement listing is ON, and is determined as a value equal to the initial rank index of the N+1^{th} ranked advertisement listing when bid management on/off information of the N+1^{th} ranked advertisement listing is OFF.

10. The method of claim 9, wherein the initial rank index of the N+1^{th} ranked advertisement listing is determined as a value equal to the initial rank index of the N+1^{th} ranked advertisement listing when the N+1^{th} ranked advertisement listing is lowest in rank.

11. A bid management method comprising:
assigning an advertisement listing to an advertisement group based on rank setting information;
extracting an advertisement listing to be displayed in a rank section from the advertisement listing using the advertisement group; and
adjusting a bid amount of the advertisement listing.

12. The method of claim 11, wherein the assigning of the advertisement listing to the advertisement group based on the rank setting information comprises assigning the advertisement listing to the advertisement group based on the rank setting information including bid management on/off information, a desired display rank, or display setting on/off information.

13. The method of claim 11, wherein the extracting of the advertisement listing to be displayed in the rank section from the advertisement listing using the advertisement group comprises:
setting at least one rank section based on the advertisement group;
distributing the advertisement listing to each rank section; and
determining a display rank of the advertisement listing for each rank section.

14. The method of claim 13, wherein the distributing of the advertisement listing to each rank section comprises:
arranging the advertisement listing based on an initial rank index for each rank section based on the advertisement group; and
locating the advertisement listing in each rank section based on the number of inventories of each rank section,
the initial rank index is determined based on an initial bid amount and a quality index of the advertisement listing.

15. The method of claim 13, wherein the determining of the display rank of the advertisement listing for each rank section comprises:
arranging an advertisement listing for bid management based on a quality index for each rank section;
arranging an advertisement listing not for bid management based on an initial rank index for each rank section; and
calculating the display rank of the advertisement listing based on the rank setting information for each rank section.

16. The method of claim 11, wherein the adjusting of the bid amount of the advertisement listing comprises adjusting the initial bid amount of the advertisement listing using an initial rank index of a next-ranked advertisement listing in the rank section of the advertisement listing, when the advertisement listing is a target for bid management, and maintaining the initial bid amount of the advertisement listing set in bidding, when the advertisement listing is not a target for bid management.

17. The method of claim 16, wherein the adjusting of the bid amount of the advertisement listing comprises adjusting the initial bid amount of the advertisement listing by applying the quality index of the advertisement listing to the initial rank index of the next-ranked advertisement listing when the advertisement listing is a target for bid management, and determining a final bid amount of the advertisement listing as a minimum bid amount of the advertisement listing set in advance when the rank section of the advertisement listing is a lowest rank section.

18. A bid management system comprising:
a bid request receiving unit to receive a bid request including bid attribute information of an advertisement listing;
a display rank determining unit to determine a display rank of the advertisement listing using the bid attribute information; and
a bid amount calculating unit to calculate a final bid amount of the advertisement listing based on the display rank of the advertisement listing.

19. The system of claim 18, wherein the bid attribute information includes (1) an initial bid amount, (2) a desired display rank, (3) bid management on/off information for determining whether an advertisement listing is a target for bid management, and (4) display setting on/off information for determining whether to display an advertisement listing based on whether a display rank of the advertisement listing meets a desired display rank of the advertisement listing.

20. The system of claim 18, wherein the display rank determining unit comprises:
an initial rank determining unit to determine an initial rank of the advertisement listing using an initial rank index based on the initial bid amount;
a first display determining unit to determine whether to display the advertisement listing using the bid management on/off information;
a second display determining unit to determine whether to display the advertisement listing using the initial rank and the desired display rank; and
a third display determining unit to determine whether to display the advertisement listing using the display setting on/off information.

21. The system of claim 20, wherein the initial rank determining unit determines the initial rank of the advertisement listing by arranging the initial rank index of the advertisement listing based on the initial bid amount and a quality index of the advertisement listing.

22. The system of claim 18, wherein the bid amount calculating unit calculates a final bid amount of an N^{th} advertisement listing by applying a quality index of the N^{th} advertisement listing to an initial rank index of an N+1^{th} ranked advertisement listing.

23. A bid management system comprising:
an advertisement assigning unit to assign an advertisement listing to an advertisement group based on rank setting information;
an advertisement extracting unit to extract an advertisement listing to be displayed in a rank section from the advertisement listing; and
a bid amount adjusting unit to adjust a bid amount of the advertisement listing.

24. The system of claim 23, wherein the advertisement assigning unit assigns the
advertisement listing to the advertisement group based on the rank setting information including advertisement type information depending on bid management on/off information, desired display rank information, or display setting information.

25. The system of claim 23, wherein the advertisement extracting unit comprises:
a rank section setting unit to set at least one rank section based on the advertisement group;
an advertisement distributing unit to distribute the advertisement listing to each rank section; and
a display rank determining unit to determine a display rank of the advertisement listing for each rank section.
